(19) United States
(12) Patent Application Publication
(10) Pub. No.: US 2011/0065886 A1
(43) Pub. Date: Mar. 17, 2011

(54) PROCESS FOR PREPARING HYPERBRANCHED, DENDRITIC POLYURETHANES BY MEANS OF REACTIVE EXTRUSION

(75) Inventors: Thomas Weihrauch, Duelmen (DE); Stefan Bernhardt, Offenbach (DE); Matthias Seiler, Griesheim (DE); Kerstin Andres, Gronau (DE); Markus Schwarz, Haltern am See (DE); Silvia Herda, Herne (DE)

(73) Assignee: Evonik Degussa GmbH, Essen (DE)

(21) Appl. No.: 12/682,022

(22) PCT Filed: Aug. 13, 2008
(86) PCT No.: PCT/EP2008/060605

§ 371 Date: Sep. 28, 2010

(30) Foreign Application Priority Data
Oct. 12, 2007 (DE) 102007049328.4

(51) Int. Cl. C08G 18/72

(52) U.S. Cl. 528/85

(57) ABSTRACT

The present invention relates to a process for preparing hyperbranched, dendritic polyurethanes by means of reactive extrusion.

The present invention relates to a process for preparing hyperbranched, dendritic polyurethanes by means of reactive extrusion.

Hyperbranched polymers are already known. C. Gao Hyperbranched polymers: from synthesis to applications Prog. Polym. Sci. 29 (2004) 183-275 summarizes the present state of the art in this field and deals in particular with the different synthesis variants and the different fields of application of hyperbranched polymers. One of the subjects discussed is the use of isophorone diisocyanate for preparing hyperbranched polyurethanes.

EP 1 026 185 A1 discloses a process for preparing dendritic or highly branched polyurethanes by reacting diisocyanates and/or polyisocyanates with compounds having at least two isocyanate-reactive groups, at least one of the reaction partners containing functional groups with a reactivity which is different from that of the other reaction partner, and the reaction conditions being selected such that only particular reactive groups react with one another in each reaction step.

Preferred isocyanates include aliphatic isocyanates, such as isophorone diisocyanate. Named examples of the compounds having at least two isocyanate-reactive groups are, by name, propylene glycol, glycerol, mercaptoethanol, ethanolamine, N-methylethanolamine, diethanolamine, ethanolpropanolamine, dipropanolamine, diisopropanolamine, 2-amino-1,3-propanediol, 2-amino-2-methyl-1,3-propanediol and tris(hydroxymethyl)amino-methane.

The polyurethanes obtainable by the process are intended to serve as crosslinkers for polyurethanes or as building blocks for other polyaddition or polycondensation polymers, as phase mediators, thixotropic agents or nucleating reagents or as active-substance carriers or catalyst supports.

DE 100 30 869 A1 describes a process for preparing polyfunctional polyisocyanate polyaddition products, comprising
(i) preparing an addition product (A) by reacting
   a) an at least trifunctional component (a1) which is reactive with isocyanate groups, or a difunctional component (a2) which is reactive with isocyanate groups, or with a mixture of components (a1) and (a2), with
   b) diisocyanate or polyisocyanate, the reaction ratio being selected such that the addition product (A) contains on average one isocyanate group and more than one group which is reactive with isocyanate groups,
(ii) subjecting the addition product (A), if desired, to intermolecular addition reaction to give a polyaddition product (P) which contains on average one isocyanate group and more than two groups which are reactive with isocyanate groups, and
(iii) reacting the addition product (A) or the polyaddition product (P) with an at least difunctional component (c) which is reactive with isocyanate groups.

Examples given for the compound (a) include glycerol, trimethylolmethane and 1,2,4-butanetriol. A preferred diisocyanate (b) is isophorone diisocyanate.

The polyisocyanate polyaddition products obtainable by the process are proposed in particular for the preparation of coating materials, coverings, adhesives, sealants, casting elastomers and foams.

WO 2004/101624 discloses the preparation of dendritic or hyperbranched polyurethanes by
1) reacting diols or polyols containing at least one tertiary nitrogen atom and at least two hydroxyl groups having different reactivity towards isocyanate groups with diisocyanates or polyisocyanates, such as isophorone diisocyanate, to give an addition product, the diols or polyols and diisocyanates or polyisocyanates being selected such that the addition product contains on average one isocyanate group and more than one hydroxyl group, or one hydroxyl group and more than one isocyanate group.
2) reacting the addition product from step 1) to give a polyaddition product, by intermolecular reaction of the hydroxyl groups with the isocyanate groups, it also being possible for reaction to take place first of all with a compound containing at least two hydroxyl groups, mercapto groups, amino groups or isocyanate groups,
3) if desired, reacting the polyaddition product from step 2) with a compound containing at least two hydroxyl groups, mercapto groups, amino groups or isocyanate groups.

The polyaminourethanes obtainable by the process are proposed as crosslinkers for polyurethane systems or as building blocks for other polyaddition or polycondensation polymers, as phase mediators, as rheological assistants, as thixotropic agents, as nucleating reagents or as active-substance carriers or catalyst supports.

WO 02/068553 A2 describes a coating composition comprising
1) a carbamate resin having a hyperbranched or star-shaped polyol core, with a first chain section based on a polycarboxylic acid or a polycarboxylic anhydride, with a second chain section based on an epoxide, and with carbamate groups on the core and/or the second chain section, and
2) a second resin containing reactive groups which are able to react with the carbamate groups of the carbamate resin.

The polyol core can be obtained by reacting a first compound, containing more than 2 hydroxyl groups, such as 1,2,6-hexanetriol, with a second compound, containing a carboxyl group and at least two hydroxyl groups.

The carbamate groups can be introduced by reaction with aliphatic or cycloaliphatic diisocyanates. As part of a relatively long listing, isocyanates specified in this context include 2,2,4- and 2,4,4-trimethyl-1,6-diiso-cyanatohexane and isophorone diisocyanate.

WO 97/02304 relates to highly functionalized polyurethanes composed of molecules with the functional groups A(B)ₙ, with A being an NCO group or a group which is reactive with an NCO group, B being an NCO group or a group which is reactive with an NCO group, A being reactive with B, and n being a natural number which is at least 2. The monomer A(B)ₙ can be prepared, for example, starting from isophorone diisocyanate.

In view of this prior art it was an object of the present invention to prepare hyperbranched polyurethanes extremely simply on an industrial scale.

The present invention provides a process for the solvent-free, continuous preparation of hyperbranched, dendritic polyurethanes obtained by solvent-free reaction of
A) at least one aromatic, aliphatic, (cyclo)aliphatic and/or cycloaliphatic polyisocyanate having at least two NCO groups and
B) at least one monomeric, oligomeric and/or polymeric polyol having at least two OH groups;
C) in the presence of urethanization catalysts in a concentration of 0.01% to 3% by weight, based on the total mass;
   in the possible presence of further auxiliaries and additives,
   in an extruder, flow tube, intensive kneader, intensive mixer or static mixer, by intense commixing and short-duration reaction with heat supply at temperatures >25° C. and subsequent isolation of the end product, more particularly by means of rapid cooling.

Highly branched globular polymers are referred to in the technical literature by terms which include that of “dendritic polymers”. These dendritic polymers, synthesized from polyfunctional monomers, can be divided into two different categories, the “dendrimers” and the “hyperbranched polymers”. Dendrimers possess highly regular, radially symmetric generational structure. They represent monodisperse globular polymers which, in comparison to hyperbranched polymers, are prepared in multistep syntheses with a high degree of synthetic complexity. The structure in this case is characterized by three different areas: the polyfunctional core, which represents the centre of symmetry; different, well-defined radially symmetric layers of one repeating unit (generation); and the terminal groups. In contrast to the dendrimers, the hyperbranched polymers are polydisperse and are irregular in terms of their branching and structure. Besides the dendritic units and terminal units, hyperbranched polymers differ from dendrimers in containing linear units as well. An example of a dendrimer and of a highly branched polymer, constructed from repeating units which in each case contain at least three bonding possibilities, is shown respectively in the following structures:

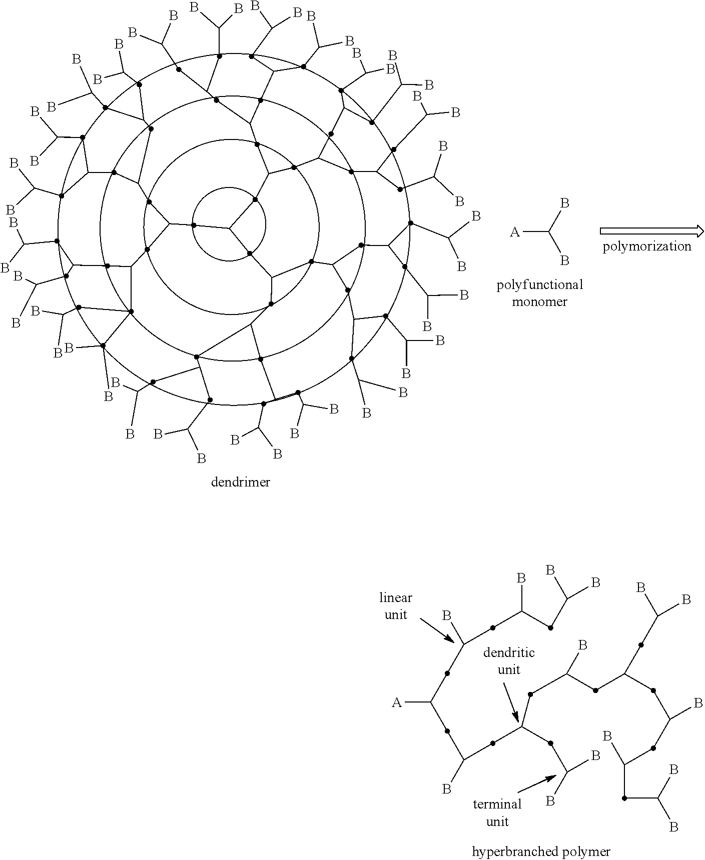

With respect to the various possibilities relating to the synthesis of dendrimers and hyperbranched polymers, reference may be made in particular to
a) Fréchet J. M. J., Tomalia D. A. “Dendrimers And Other Dendritic Polymers” John Wiley & Sons, Ltd., West Sussex, UK 2001 and also
b) Jikei M., Kakimoto M. “Hyperbranched Polymers: A Promising New Class Of Materials” Prog. Polym. Sci., 26 (2001) 1233-85 and/or
c) Gao C., Yan D. “Hyperbranched Polymers: From Synthesis To Applications” Prog. Polym. Sci., 29 (2004) 183-275,
   which are hereby introduced as references and are considered part of the disclosure content of the present invention.

Starting materials for the polyisocyanates A: Suitable aromatic diisocyanates or polyisocyanates include in principle all known compounds. Particular suitability is possessed by phenylene 1,3- and 1,4-diisocyanate, naphthylene 1,5-diisocyanate, toluidine diisocyanate, tolylene 2,6-diisocyanate, tolylene 2,4-diisocyanate (2,4-TDI), diphenylmethane 2,4′-di-isocyanate (2,4′-MDI), diphenylmethane 4,4′-diisocyanate, the mixtures of monomeric diphenylmethane diisocyanates (MDI) and oligomeric diphenylmethane diisocyanates (polymer MDI), xylylene diisocyanate, tetramethylxylylene diisocyanate and triisocyanatotoluene.

Suitable aliphatic diisocyanates or polyisocyanates possess advantageously 3 to 16 carbon atoms, preferably 4 to 12 carbon atoms, in the linear or branched alkylene radical, and suitable cycloaliphatic or (cyclo)aliphatic diisocyanates possess advantageously 4 to 18 carbon atoms, preferably 6 to 15 carbon atoms, in the cycloalkylene radical. By (cyclo)aliphatic diiso-cyanates the skilled person means NCO groups which are sufficiently attached cyclically and aliphatically at the same time, as is the case, for example, for isophorone diisocyanate. By cycloaliphatic diiso-cyanates, in contrast, are meant those which contain only NCO groups attached directly to the cycloaliphatic ring, an example being H₁₂MDI. Examples are cyclohexane diisocyanate and methylcyclohexane diisocyanate.

Preference is given to isophorone diisocyanate (IPDI), hexamethylene diisocyanate (HDI), diisocyanatodicyclo-hexylmethane (H₁₂MDI), 2-methylpentane diisocyanate (MPDI), 2,2,4-trimethylhexamethylene diisocyanate/-2,4,4-trimethylhexamethylene diisocyanate (TMDI) and norbornane diisocyanate (NBDI). Very particular preference is given to using IPDI, HDI, TMD₁ and H₁₂MDI, with the use of the isocyanurates and uretdiones also being possible.

Likewise suitable are 4-methylcyclohexane 1,3-diiso-cyanate, 2-butyl-2-ethylpentamethylene diisocyanate, 3(4)-isocyanatomethyl-1-methylcyclohexyl isocyanate, 2-isocyanatopropylcyclohexyl isocyanate, 2,4′-methylenebis(cyclohexyl) diisocyanate and 1,4-diiso-cyanato-4-methylpentane.

It is of course also possible to use mixtures of the diisocyanates and polyisocyanates, isocyanurates and uretdiones.

In addition it is preferred to use oligoisocyanates or polyisocyanates which can be prepared from the aforementioned diisocyanates or polyisocyanates, or mixtures thereof, by linking by means of urethane, allophanate, urea, biuret, uretdione, amide, isocyanurate, carbodiimide, uretonimine, oxadiazinetrione or imino-oxadiazinedione structures. Particular suitability is possessed by isocyanurates, especially those of IPDI and HDI.

Suitable compounds B) are all of the polyols, having at least two alcohol groups, with a molecular weight of at least 32 g/mol, that are typically employed in PU chemistry.

The monomeric diols are, for example, ethylene glycol, triethylene glycol, butane-1,4-diol, pentane-1,5-diol, hexane-1,6-diol, 3-methylpentane-1,5-diol, neopentyl glycol, 2,2,4(2,4,4)-trimethylhexanediol and neopentyl glycol hydroxypivalate.

The monomeric triols are, for example, trimethylolpropane, ditrimethylolpropane, trimethylol-ethane, hexane-1,2,6-triol, butane-1,2,4-triol, tris(β-hydroxyethyl) isocyanurate, pentaerythritol, mannitol or sorbitol.

Also suitable are polyols which contain further functional groups (oligomers or polymers). These are the conventional hydroxyl-containing polyesters, polycarbonates, polycaprolactones, polyethers, polythioethers, polyesteramides, polyurethanes or polyacetals. They possess a number-average molecular weight of 134 to 3500 g/mol. The polyols are used alone or in mixtures.

The catalysts C) are urethanization catalysts, such as organotin compounds of the following composition RₙSnXₘ (II), in which R=alkyl radical having 1 to 10 carbon atoms and X=carboxylate radical of a carboxylic acid having 1 to 20 carbon atoms, and n=1, 2 or 3, m=1, 2 or 3 and n+m=4. They also include zinc catalysts, such as, more particularly, for example, zinc 2-ethylhexanolate in butyl diglycol, zinc salts of branched and unbranched fatty acids (C2-C20), or bismuth catalysts, such as bismuth trisneodecanoate in neodecanoic acid. They are used in a concentration of 0.01% to 3% by weight.

Particular suitability is possessed by catalysts such as butyltin tris(2-ethylhexanoate) and dibutyltin dilaurate.

Examples of auxiliaries and additives include monofunctional isocyanates, chain terminators, blocking agents, chain extenders, degassing agents, stabilizers, further catalysts, flow control agents, organic and/or inorganic pigments and/or fillers, dispersants, wetting agents, defoamers and ionic liquids.

The hyperbranched polyurethane prepared in accordance with the invention preferably has a weight-average molecular weight Mw in the range from 1000 g/mol to 200 000 g/mol, more favourably in the range from 1500 g/mol to 100 000 g/mol, with particular preference in the range from 2000 g/mol to 75 000 g/mol and more particularly in the range from 2500 g/mol to 50 000 g/mol.

The determination of the molecular weight, particularly the determination of the weight-average molecular weight Mw and the number-average molecular weight, can be measured in a way which is known per se, by means for example of gel permeation chromatography (GPC), the measurement taking place preferably in DMF with polyethylene glycols, preferably, being employed as reference material (cf., inter alia, Burgath et al. in Macromol. Chem. Phys., 201 (2000) 782-91). In this context it is judicious to use a calibration plot obtained, favourably, using polystyrene standards. These parameters therefore constitute apparent measured values.

Alternatively the number-average molecular weight can also be determined by vapour or membrane osmosis, which are described in more detail in, for example, K. F. Arndt; G. Müller; Polymercharakterisierung; Hanser Verlag 1996 (vapour pressure osmosis) and H. -G. Elias, Makromoleküle Struktur Synthese Eigenschaften, Hütig & Wepf Verlag 1990 (membrane osmosis). GPC, however, has proven very particularly appropriate in accordance with the invention.

The polydispersity Mw/Mn of preferred hyperbranched polyurethanes is preferably in the range of 1-50, more favourably in the range of 1.1-40, in particular in the range of 1.2-20, preferably up to 10.

The principle of the process is that the reaction of the starting compounds takes place, continuously, more particularly in an extruder, flow tube, intensive kneader, intensive mixer or static mixer by intense commixing and short-duration reaction with supply of heat. This means that the residence time of the reactants in the abovementioned assemblies is typically seconds to 15 minutes, preferably 3 seconds to 5 minutes, more preferably 5 to 180 seconds. The reactants are reacted with short duration and with heat supply at temperatures from 25° C. to 325° C., preferably from 50 to 250° C., very preferably from 50 to 200° C.

Depending on the identity of the reactants and of the end products, however, these figures for residence time and temperature may also occupy other preferred ranges. Where appropriate, a continuous afterreaction is carried out afterwards. Subsequent rapid cooling then allows the desired end product to be obtained.

As assemblies, extruders such as single-screw or multi-screw extruders, more particularly twin-screw extruders, planetary roller extruders or annular extruders, flow tubes, intensive kneaders, intensive mixers or static mixers are particularly suitable and used with preference for the process of the invention.

Since the cooling of the products can be very important for the molecular build-up, it may be necessary to modify the extruders in the head region or to use particular die constructions. It is frequently necessary here to enable the product to be discharged particularly gently. One possibility for achieving this, for example, is to operate without a head plate.

The starting compounds are metered to the assemblies generally in separate product streams. Where there are more than two product streams, they may also be supplied in unison. Different hydroxyl-containing starting materials can be combined into one product stream. It is also possible additionally to add catalysts and/or adjuvants such as flow control agents, or stabilizers, to this product stream. Similarly, polyisocyanates, and also the uretdione or uretdiones of polyisocyanates, can be combined with catalysts and/or adjuvants such as flow control agents or stabilizers into one product stream. The steams may also be divided and so supplied in different proportions to different sites in the assemblies. In this way, in a targeted fashion, concentration gradients are set up, and this may induce the reaction to proceed to completion. The entry point of the product streams can be varied in sequence and offset in time. This allows the construction of the target molecules to be varied.

For a preliminary reaction and/or for completion of the reaction it is also possible for two or more assemblies to be combined.

The preferably rapid cooling downstream of the reaction can be integrated in the reaction section, in the form of a multi-barrel embodiment as in the case of extruders or Conterna machines. The following may also be employed: tube bundles, tubular coils, chill rolls, cooled chutes, air conveyors, metal conveyor belts and water baths, with and without a downstream pelletizer.

The formulation is first of all brought to an appropriate temperature by means of further cooling using corresponding aforementioned apparatus, depending on the viscosity of the product leaving the intensive kneader zone or the afterreaction zone. This cooling procedure is followed by pelletizing or else by comminution to a desired particle size by means of a roll crusher, pin mill, hammer mill, flaking rolls, strand pelletizer (in combination with a cooling medium, for example), other pelletizers or similar.

The invention is illustrated below with reference to an example.

### EXAMPLE 1

### Preparation of a Hyperbranched, Dendritic Polyurethane by the Process of the Invention

| Starting materials | Product description, manufacturer |
|---|---|
| IPDI | DEGUSSA AG |
| 1,2,6-Hexanetriol | DEGUSSA AG |
| Catalyst | Dibutyltin dilaurate, Aldrich |

Three streams were operated:

Stream 1 consisted of 1,2,6-hexanetriol.
Stream 2 consisted of isophorone diisocyanates (IPDI).
Stream 3 consisted of the catalyst DBTL. The total amount, based on the overall formula, was 0.025%.

Stream 1 was fed as a melt at a rate of 630 g/h into the first barrel of a twin-screw extruder (DSE 25) (temperature of the stream: 25° C.)

Stream 2 was fed into the subsequent barrel at a rate of 2510 g/h (temperature of the stream: 25° C.)

Stream 3 was introduced into stream 2 prior to its entry into the extruder, via a static mixer section (0.78 g/h).

The extruder used consisted of 8 barrels, which were separately heatable and coolable. Barrels 1, 2 and 3: 20-30° C., barrel 4: 25-35° C., barrel 5: 55-65° C., barrels 6 and 7: 150-165° C., barrel 8: 100-105° C.

The screws were equipped with conveying elements.

All of the temperatures represented setpoint temperatures. Regulation took place via electrical heating and water cooling, respectively. No extruder head was used. The screw speed was 250 rpm. After exit from the extruder, the reaction product was immediately cooled and discharged on a cooling belt and then ground. It had a free NCO group content of 12.1%.

| Throughput (kg/h) | 3.14 kg/h |
|---|---|
| Molar ratio hexanetriol/IPDI | 1.00/2.40 |

1. A process for the solvent-free, continuous preparation of a hyperbranched, dendritic polyurethane obtained by solvent-free reaction of
A) at least one aromatic, aliphatic, (cyclo)aliphatic and/or cycloaliphatic polyisocyanate having at least two NCO groups and
B) at least one monomeric, oligomeric and/or polymeric polyol having at least two OH groups;
C) in the presence of urethanization catalysts in a concentration of 0.01% to 3% by weight, based on the total mass;
in the possible presence of further auxiliaries and additives,
in an extruder, flow tube, intensive kneader, intensive mixer or static mixer, by intense commixing and short-duration reaction with heat supply at temperatures >25° C. and subsequent isolation of the end product by means of rapid cooling.

2. The process according to claim 1, wherein the residence time of the reactants is 3 seconds to 15 minutes.

3. The process according to claim 1, wherein the reaction takes place in a single-screw, twin-screw or multi-screw extruder, annular extruder or planetary roller extruder.

4. The process according to claim 3, wherein the reaction takes place in a twin-screw extruder.

5. The process according to claim 1, wherein the reaction takes place in a multi-shaft extruder.

6. The process according to claim 1, wherein the reaction takes place in a flow tube, intensive mixer or intensive kneader.

7. The process according to claim 1, wherein the reaction takes place in a static mixer.

8. The process according to claim 1, wherein the reaction takes place in an extruder, intensive kneader, intensive mixer or static mixer having two or more identical or different barrels which can be thermally controlled independently of one another.

9. The process according to claim 1, wherein the temperature in the extruder, intensive kneader, intensive mixer or static mixer is >25 to 325° C.

10. The process according to claim 1, wherein, by suitable equipping of the mixing chambers and composition of the screw geometry, on the one hand, the extruder or intensive kneader leads to intense rapid commixing and rapid reaction in conjunction with intense heat exchange, and, on the other hand, produces an even flow in the longitudinal direction with a very highly uniform residence time, the end of the extruder allowing the rapid cooling of the emergent product.

11. The process according to claim 1, wherein the reactants and/or catalysts and/or adjuvants are supplied together or in separate product streams, in liquid or solid form, to the extruder, flow tube, intensive kneader, intensive mixer or static mixer.

12. The process according to claim 1, wherein the adjuvants are combined with the reactants into one product stream.

13. The process according to claim 1, wherein isophorone diisocyanate (IPDI), hexamethylene diisocyanate (HDI), diisocyanatodicyclohexylmethane (H₁₂MDI) 2 methylpentane diisocyanate (MPDI), 2,2,4-trimethylhexamethylene diisocyanate/2,4,4-trimethylhexamethylene diisocyanate (TMDI), norbornane diisocyanate (NBDI), toluidine diisocyanate (TDI), methylenediphenyl diisocyanate (MDI) and/or tetramethylxylylene diisocyanate (TMXDI) are/is used as component A).

14. The process according to claim 1, wherein IPDI, HDI and/or H₁₂MDI are/is used as component A).

15. The process according to claim 1, wherein 4-methyl-cyclohexane 1,3-diisocyanate, 2-butyl-2-ethylpentamethylene diisocyanate, 3(4)-isocyanatomethyl-1-methylcyclohexyl isocyanate, 2 isocyanatopropylcyclohexyl isocyanate, 2,4′-methylenebis(cyclohexyl) diisocyanate and/or 1,4 diisocyanato-4-methylpentane are/is used as component A).

16. The process according to claim 1, wherein component A) is selected from an aromatic, aliphatic, cycloaliphatic or (cyclo)aliphatic diisocyanate or polyisocyanate, alone or in mixtures, and/or from oligoisocyanate and/or polyisocyanate containing urethane, allophanate, urea, biuret, uretdione, amide, isocyanurate, carbodiimide, uretonimine, oxadiazinetrione or iminooxadiazinedione structures.

17. The process according to claim 1, wherein isocyanurates, biurets and/or allophanates are used as component A).

18. The process according to claim 1, wherein isocyanurates, from IPDI and HDI, are used as component A).

19. The process according to claim 1, that wherein ethylene glycol, triethylene glycol, butane-1,4-diol, pentane-1,5-diol, hexane-1,6-diol, 3-methylpentane-1,5-diol, neopentyl glycol, 2,2,4(2,4,4)-trimethylhexanediol, neopentyl glycol hydroxypivalate, trimethylolpropane, ditrimethylolpropane, trimethylolethane, hexane-1,2,6-triol, butane-1,2,4-triol, tris(β-hydroxyethyl) isocyanurate, pentaerythritol, mannitol, sorbitol, hydroxyl-containing polyesters, polycarbonates, polycaprolactones, polyethers, polythioethers, polyesteramides, polyurethanes and/or polyacetals, alone or in a mixture, are used as polyols B).

20. The process according to claim 1, wherein organotin compounds of composition
RₙSnXₘ
in which R=alkyl radical having 1 to 10 carbon atoms and X=carboxylate radical of a carboxylic acid having 1 to 20 carbon atoms and n=1, 2 or 3, m=1, 2 or 3 and n+m=4
are used as catalysts C).

21. The process according to claim 1, wherein zinc catalysts, such as, more particularly, zinc 2-ethylhexanolate in butyl diglycol, zinc salts of branched and unbranched fatty acids (C2-C20), or bismuth catalysts, such as, more particularly, bismuth trisneodecanoate in neodecanoic acid, are used.

22. The process according to claim 1, wherein butyltin tris(2-ethylhexanoate) and/or dibutyltin dilaurate are used as catalysts C).

23. The process according to claim 1, wherein a product having a weight-average molecular weight in the range from 1000 to 200 000 g/mol is produced.
